(19) United States
(12) Patent Application Publication
(10) Pub. No.: US 2020/0346114 A1
(43) Pub. Date: Nov. 5, 2020

(54) CONTEXTUAL IN-GAME ELEMENT RECOGNITION AND DYNAMIC ADVERTISEMENT OVERLAY

(71) Applicant: Microsoft Technology Licensing, LLC, Redmond, WA (US)

(72) Inventors: Arunabh P. Verma, Seattle, WA (US); Eric Hamilton, Bothell, WA (US); Raman K. Sarin, Redmond, WA (US)

(21) Appl. No.: 16/399,664

(22) Filed: Apr. 30, 2019

(51) Int. Cl. A63F 13/537

(52) U.S. Cl. CPC A63F 13/537

(57) ABSTRACT

Systems, methods, and apparatuses are provided for overlaying content on a video frame generated by a video game. A content overlay engine may be executed concurrently with the execution of a video game. An element recognizer may obtain the video frame and identify an element of the video game in the frame, such as an in-game element. A renderability determiner may determine whether an overlay may be rendered on the element. Based at least on a determination that the overlay is renderable, a content renderer may be configured to overlay the content on the element. The overlaid content may be provided in various ways, such as presenting an overlaid video frame to a local computing device (e.g., a gaming console or a computer), and/or transmitting the overlaid video frame to a remotely located computing device.

### BACKGROUND

Gaming systems provide a wide variety of dynamic and interactive content to a user. For example, video games can display numerous objects on a screen during the course of a user's gameplay, including both moving and stationary objects. The presentation of such objects, however, is generally based on a given user's actions, and can change each time the user plays a game. Furthermore, when such objects are displayed to a user, gaming systems typically display the objects to the user in the manner that the game developer originally intended. As a result, while the location or colors of a given object may change based on a user's actions or selections, other details of the object typically remain static during gameplay.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Systems, methods, and computer program products are provided for overlaying content on a video frame generated by a video game. A content overlay engine may be executed concurrently with the execution of a video game. An element recognizer may obtain the video frame and identify an element of the video game in the frame, such as an in-game element. A renderability determiner may determine whether an overlay may be rendered on the element. Based at least on a determination that the overlay is renderable, a content renderer may be configured to overlay the content on the element. The overlaid content may be provided in various ways, such as presenting an overlaid video frame to a local computing device (e.g., a gaming console or a computer), and/or transmitting the overlaid video frame to a remotely located computing device.

In this manner, content such as advertisements, logos, etc. may be dynamically overlaid on in-game elements of a video game currently being played in real-time. For instance, an advertisement may be overlaid on a billboard in a racing game such that the overlaid advertisement appears as a part of the game itself. As a result, content may be overlaid automatically and seamlessly during the execution of a game.

Further features and advantages, as well as the structure and operation of various example embodiments, are described in detail below with reference to the accompanying drawings. It is noted that the example implementations are not limited to the specific embodiments described herein. Such example embodiments are presented herein for illustrative purposes only. Additional implementations will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate example embodiments of the present application and, together with the description, further serve to explain the principles of the embodiments and to enable a person skilled in the pertinent art to make and use the example embodiments.

FIG. 1 shows a block diagram of a system for overlaying content, according to an example embodiment.

FIG. 2 shows a flowchart of a method for overlaying content on an element in a video frame of a video game, according to an example embodiment.

FIG. 3 shows a block diagram of a content overlay engine, according to an example embodiment.

FIG. 4 shows a flowchart of a method for applying a video game model, according to an example embodiment.

FIG. 5 shows a flowchart of a method for obtaining an advertisement, according to an example embodiment.

FIG. 6 shows a flowchart of a method for blending overlaid content into a video frame, according to an example embodiment.

FIG. 7 shows a flowchart of a method for providing an incentive to a user account, according to an example embodiment.

FIG. 8 shows a flowchart of a method for generating a plurality of output frames, according to an example embodiment.

FIG. 9 shows a block diagram of a system for providing video frames with overlaid content to a plurality of devices, according to an example embodiment.

FIG. 10 shows example content overlays on a video frame of a video game, according to an example embodiment.

FIG. 11 is a block diagram of an example processor-based computer system that may be used to implement various example embodiments.

The features and advantages of the implementations described herein will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification and accompanying drawings disclose numerous example implementations. The scope of the present application is not limited to the disclosed implementations, but also encompasses combinations of the disclosed implementations, as well as modifications to the disclosed implementations. References in the specification to “one implementation,” “an implementation,” “an example embodiment,” “example implementation,” or the like, indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of persons skilled in the relevant art(s) to implement such feature, structure, or characteristic in connection with other implementations whether or not explicitly described.

In the discussion, unless otherwise stated, adjectives such as “substantially” and “about” modifying a condition or relationship characteristic of a feature or features of an implementation of the disclosure, are understood to mean that the condition or characteristic is defined to within tolerances that are acceptable for operation of the implementation for an application for which it is intended.

Numerous example embodiments are described as follows. It is noted that any section/subsection headings provided herein are not intended to be limiting. Implementations are described throughout this document, and any type of implementation may be included under any section/subsection. Furthermore, implementations disclosed in any section/subsection may be combined with any other implementations described in the same section/subsection and/or a different section/subsection in any manner.

### II. Example Implementations

Gaming systems provide a wide variety of dynamic and interactive content to a user. For example, video games can display numerous objects on a screen during the course of a user's gameplay, including both moving and stationary objects. The presentation of such objects, however, is generally based on a given user's actions, and can change each time the user plays a game. Furthermore, when such objects are displayed to a user, gaming systems typically display the objects to the user in the manner that the game developer originally intended. As a result, while the location or colors of a given object may change based on a user's actions or selections, other details of the object typically remain static during gameplay.

For instance, where an in-game element of a game, such as an on-screen player's sports jersey is presented, the content of the jersey generally remains unchanged. In other words, additional content beyond any details preprogrammed in the game itself cannot be rendered on the jersey. As a result, game content becomes difficult to expand once a game is published and therefore such games remain relatively limited from a content perspective.

Implementations described herein address these and other issues through a system for overlaying content on a video frame generated by a video game. In the system, a content overlay engine is executed at the same time as the video game. The content overlay engine may, in real-time, identify elements of the video game in the video frame, such as various on-screen game objects (e.g., license plates, billboards, jerseys, etc.). A renderability determiner may determine whether an overlay can be rendered on each identified element. For instance, it may be determined whether additional content (such as an advertisement) may be rendered on a billboard identified in the video frame. Based on the renderability determination, a content renderer may overlay the additional content onto the element in the video frame. The video frame comprising the overlaid content may then be provided to an output device, such as a local computing device, for presentation to a user in a seamless manner.

In some other implementations, the content renderer may be configured to generate a plurality of different output video frames from the same input video frame. For instance, the content renderer may generate a first and second output frame that each comprise different overlaid content on an element identified in the input frame. The output frames may then be transmitted, via a network interface, to a plurality of remote devices for presentation. As a result, additional content overlaid onto a video frame may be tailored to each remote device (e.g., based on a user preference, a device location, etc.).

This approach has numerous advantages, including but not limited to dynamically enhancing the content that may be presented during gameplay in a manner that does not require the video game itself to be preprogrammed with such content. In other words, after a game is published, additional content may be automatically overlaid onto video frames generated by the video game rather than being stored in the video game itself, thereby conserving resources (e.g., storage and/or memory resources) associated with the video game. Additionally, implementations described herein improve a graphical user interface by enhancing the interactive gaming experience for both remote viewers and the video game player. For example, by automatically overlaying additional content onto elements identified within video frames in a seamless manner, the additional content (e.g., advertisements) may be presented in a manner that utilizes available screen space while not being obstructive or distracting to users.

Still further, in systems where different processes may be executed in parallel, the content overlay engine renders overlays in parallel with the execution of the video game, enabling the video game to continue to present graphics to a user at high frame rates and/or without lag or delay. As a result, content may be seamlessly added onto an existing video game without the need for additional processing resources for video game, thereby enabling such resources to be preserved for the actual gameplay. In other words, since the video game is not utilizing resources to analyze additional content that may be presented on elements of the video frame, the video game can continue to deliver a high-performance experience, while a separate overlay engine may use parallel resources to render appropriate content on top of video frames generated by the video game.

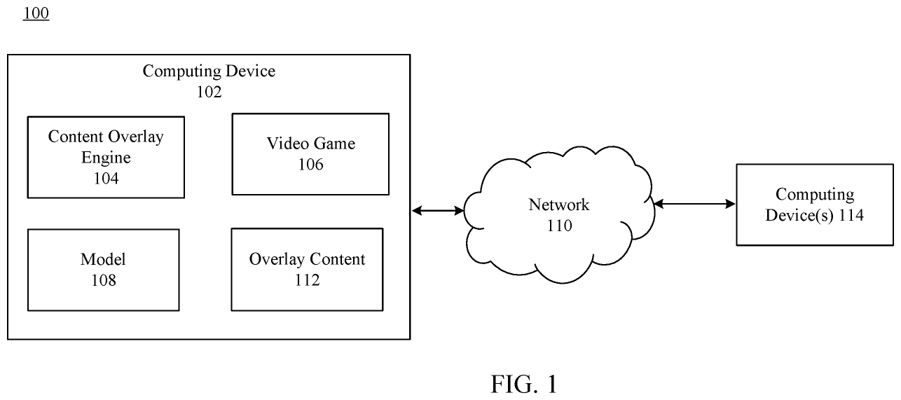

Example implementations will now be described that are directed to techniques for overlaying content on a video frame. For instance, FIG. 1 shows a block diagram of an example system 100 for overlaying content on a video frame generated by a video game, according to an example implementation. As shown in FIG. 1, system 100 includes a computing device 102, computing device 114, and a network 110.

Network 110 may comprise one or more networks such as local area networks (LANs), wide area networks (WANs), personal area network (PANs), enterprise networks, the Internet, etc., and may include wired and/or wireless portions. Computing device 102 and computing device 114 may be communicatively coupled via network 110. In an implementation, computing device 102 and computing device 114 may communicate via one or more application programming interfaces (API), and/or according to other interfaces and/or techniques. Computing device 102 and computing device 114 may each include at least one network interface that enables communications with each other. Examples of such a network interface, wired or wireless, include an IEEE 802.11 wireless LAN (WLAN) wireless interface, a Worldwide Interoperability for Microwave Access (Wi-MAX) interface, an Ethernet interface, a Universal Serial Bus (USB) interface, a cellular network interface, a Bluetooth™ interface, a near field communication (NFC) interface, etc. Further examples of network interfaces are described elsewhere herein.

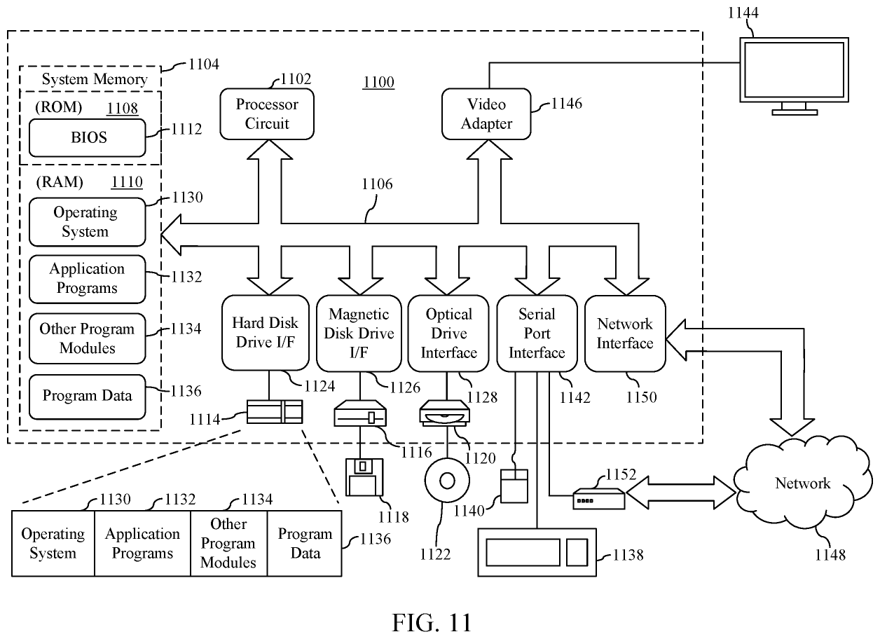

Computing device 102 comprises a content overlay engine 104, a video game 106, a model 108, and overlay content 112. In examples, computing device 102 may comprise a device configured to output a video signal comprising one or more video frames (e.g., of video game 106) to a display screen. Computing device 102 may comprise a video game console (e.g., a Microsoft Xbox® of any version, a Sony PlayStation® of any version, A Nintendo WHO, NES, or Switch™ of any version, etc.), a desktop computer, a portable computer, a smartphone, a tablet, a wearable computing device, a head mounted gaming device, a mixed and/or virtual reality device (e.g., Microsoft HoloLens™), or any other processing device for executing video game 106 and outputting video frames generated by the video game, such as to a display device (co-located with computing device 102 and/or located remotely). Although not shown in FIG. 1, a display device of computing device 102 may comprise any type of display suitable for receiving and displaying video frames generated by a video game. For instance, the display device may be a liquid crystal display, cathode ray tube display, light-emitting diode display, a plasma display, a display screen of a projector television, or any other type of display that may be coupled to computing device 102 through a suitable interface. The display device of computing device 102 may either be external to or incorporated in computing device 102. An example computing device that may incorporate the functionality of computing device 102 is discussed below in reference to FIG. 11.

Video game 106 may include any type of video game executable or playable on computing device 102. Video game 106 may comprise any type of video game genre, such as sports, action, racing, adventure, role playing, simulation, strategy, educational, etc. Video game 106 may comprise games of any level of player interaction (e.g., fast-action or fast-paced games, slow moving games, single-player games, multi-player games, etc.). As other examples, video game 106 may include games or activities such as card games (e.g., Solitaire), crossword puzzles, mathematical games, trivia games, family games etc. In implementations, video game 106 may be stored locally on computing device 102 or may be stored on a removable storage, such as a compact-disc (CD), a digital video disc (DVD), a Blu-Ray™ disc, or any other medium that may be accessed by computing device 102. In other implementations, video game 106 may be stored remotely (e.g., on a local or remotely-located server accessible via network 110) and/or streamed from a local or remote server.

Computing device(s) 114 may include one or more computing devices and/or server devices, co-located or located remotely, comprising, for instance, a cloud-based computing platform. In example embodiments, computing device(s) 114 may be configured to implement a video game model generator configured to generate and/or train model 108 that may be subsequently transmitted to computing device 102 (e.g., at a time prior to or during execution of content overlay engine 104). In some implementations, computing device(s) 114 may generate model 108 based on training data obtained from a plurality of computing devices not shown in FIG. 1, including but not limited to other computing devices that may be executing content overlay engine 104 and/or video game 106. As a result, model 108 may be generated in a manner that takes into account behaviors across a larger gaming ecosystem and subsequently transmitted to one or more computing devices during operation of content overlay engine 104.

Computing device(s) 114 may also be communicatively coupled to a storage or other repository, such as a storage device comprising one or more databases for collecting, managing, and/or storing content that may be overlaid on elements of video frames generated by video games. In some example implementations, such a storage may include overlay content 112 that may be subsequently transmitted, in whole or in part, to computing device 102 at a time prior to and/or during execution of content overlay engine 104. In one implementation, such a storage may be local to computing device(s) 114. In other implementations, such a storage may be remotely located with respect to computing device(s) 114. Computing device(s) 114 may also comprise, or be communicatively coupled to, one or more physical storage devices, including but not limited to one or more local storage devices and/or one or more cloud-based storage devices. Examples of such storage devices include hard disk drives, solid state drives, random access memory (RAM) devices, etc. An example computing device that may incorporate the functionality of computing device(s) 114 is described below in reference to FIG. 11.

Content overlay engine 104 is configured to obtain a video frame generated by video game 106 and overlay content onto the video frame for presentation (e.g., to a user via a local or remote display). For example, content overlay engine 104 may apply model 108 (e.g., a machine learning-based model) to identify elements in one or more video frames of video game 106. Such elements may comprise on-screen game objects that include, but are not limited to, jerseys, uniforms, balls, sports equipment, billboards, fields, courts, cars, roads or highways, people, animals, etc. that may be present during any frame of a video game. Content overlay engine 104 may also apply model 108 to determine whether an overlay may be rendered on the identified element. For instance, it may be determined that elements that are fast moving are not suitable for being overlaid with content, while slow-moving elements may be overlaid with content. This is only one illustrative example, and additional examples will be described in greater detail below. In examples, model 108 may be generated and/or trained on or more other computing devices, such as one of computing device(s) 114. Prior to and/or during execution of video game 106, computing device 102 may obtain model 108 from one of computing device(s) 114 via network 110, such as over a network interface coupled to the Internet. In examples, computing device 102 may store model 108 locally upon obtaining it from another such computing device (e.g., in a local storage device, a volatile memory such as a random-access memory device, etc.). Based at least on a determination that content may be overlaid onto an identified element, content overlay engine 104 may render the content as an overlay on the element in a video frame (e.g., a video frame that contains the obtained video frame with the additional content superimposed thereon). The overlaid video frame may then be provided to an output device coupled to computing device 102 that is configured to display graphics from the real-time gameplay of video game 106 to a user in a seamless manner.

In implementations, content overlay engine 104 may be executed concurrently with video game 106 such that content overlay engine 104 may present overlaid content simultaneously with the real-time gameplay of video game 106. For example, content overlay engine 104 may be configured as an application that may be executed concurrently with video game 106 on a common operating system. In other example embodiments, content overlay engine 104 may be implemented as a shell-level or top-level application executable on an operating system such that it may present additional content as graphical objects or annotations as overlays. In another example, content overlay engine 104 may implemented in an application such as Game Bar developed by Microsoft Corporation of Redmond, Wash.

In examples, overlay content 112 may comprise information that may be overlaid onto elements identified in a video frame of video game 106. Overlay content 112 may include any content, including but not limited to graphics, alphanumeric characters, colors, shapes, etc. stored in a repository or database for overlaying onto any part of the video frame (e.g., on-screen elements). In implementations, overlay content 112 may be obtained from one or more of content sources, such as computing device(s) 114 and/or one or more remotely executing services (e.g., an advertisement service). Prior to, and/or during, execution of video game 106, computing device 102 may obtain overlay content from one or more content sources and store such content locally on computing device 102, e.g., in a local storage or volatile memory. In some examples, overlay content 112 may include information such as advertisements (e.g., company trademarks, names, logos, slogans, or any other type of content generated by an advertiser or advertising agency) to promote a particular company, product, and/or service.

Content overlay engine 104 may overlay information stored in overlay content 112 onto elements of a video frame in various ways. For instance, content overlay engine 104 may overlay information stored in overlay content 112 based on the type of identified element (e.g., a license plate, a billboard, a jersey, etc.). In other examples, content overlay engine 104 may overlay information stored in overlay content 112 based on a video game title. In yet other examples, content overlay engine 104 may overlay information stored in overlay content 112 based on a location of computing device 102 or other user-based information (e.g., user preferences that may be stored in a user account). In other examples, content overlay engine 104 may overlay information stored in overlay content 112 based on a target advertisement base, including but not limited to targeted games, game genres, user locations, user age groups, user skill levels, etc. The aforementioned examples are not intended to be limiting, and additional examples will be described in greater detail below.

It will be appreciated to those skilled in the relevant arts that implementations are not limited to the illustrative arrangement shown in FIG. 1. For example, any one or more of the components illustrated in FIG. 1 may be implemented on computing devices not expressly shown, such as one or more cloud-based server devices. For instance, video game 106 may comprise a game that is not executed on computing device 102, but instead comprises a game that is executed in a cloud (e.g., on one or more cloud-based servers). In such a system, content overlay engine 104, model 108, and overlay content 112 may also be implemented on one or more cloud-based servers such that video frames from a cloud-based video game may be overlaid with content in accordance with techniques described herein.

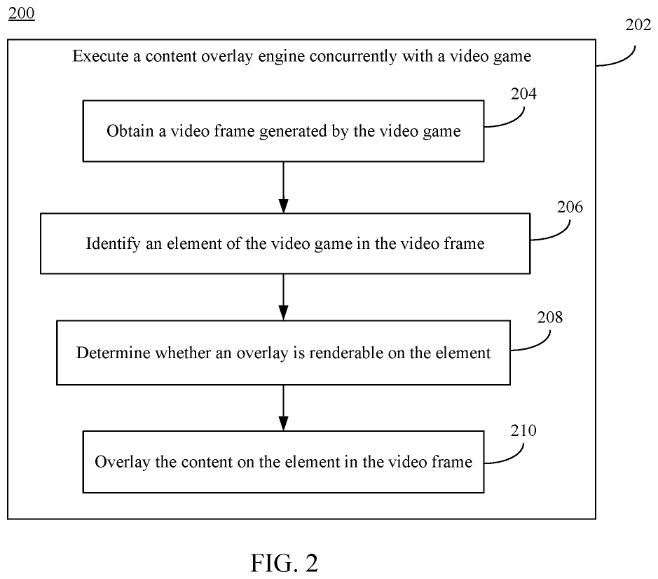

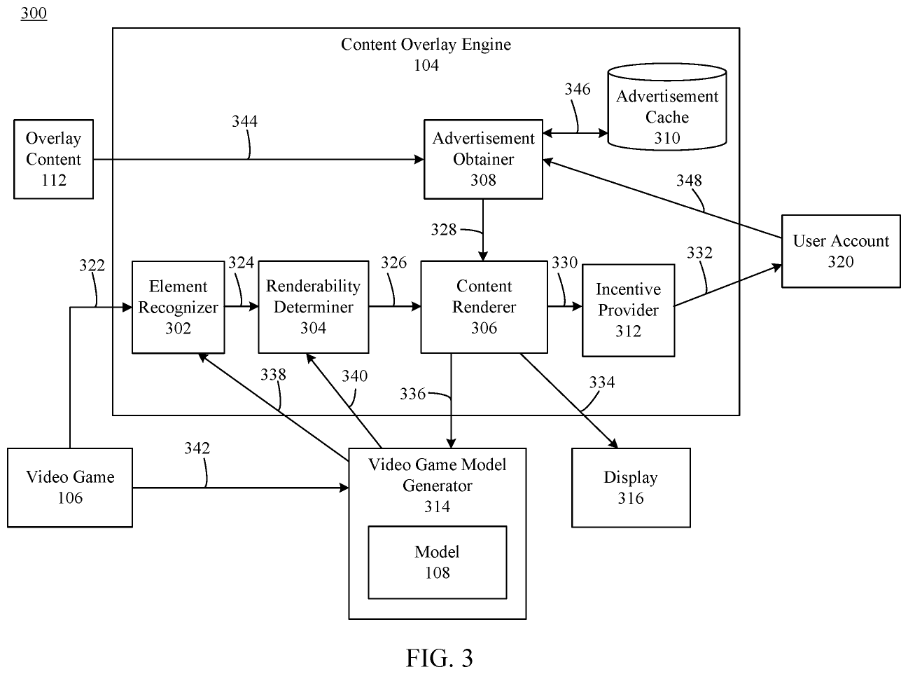

Accordingly, in implementations, overlaying content in a video frame may be achieved in various ways. For example, FIG. 2 shows a flowchart 200 of a method for overlaying content in a video frame generated by a video game, according to an example embodiment. In an implementation, the method of flowchart 200 may be implemented by content overlay engine 104. For illustrative purposes, flowchart 200 and content overlay engine 104 are described as follows with respect to FIG. 3. FIG. 3 shows a block diagram of a system 300 for overlaying content on a video frame, according to an example embodiment. As shown in FIG. 3, system 300 includes content overlay engine 104, video game 106, overlay content 112, a video game model generator 314, a display 316, and a user account 320. Content overlay engine 104 includes an element recognizer 302, a renderability determiner 304, a content renderer 306, an advertisement obtainer 308, an advertisement cache 310, and an incentive provider 312. Video game model generator 314 may be configured to generated model 108 in examples. In example implementations, video game model generator 314 may be implemented on any computing device, including one or more computing devices not expressly shown in FIG. 3. For instance, video game model generator 314 may be implemented in one or more servers communicatively coupled to content overlay engine 104 via network 110. Flowchart 200 and system 300 are described in further detail as follows.

Flowchart 200 begins with step 202. In step 202, a content overlay engine is executed concurrently with a video game. For instance, with reference to FIG. 3, content overlay engine 104 may be executed concurrently with video game 106. In implementations, upon launching video game 106, content overlay engine 104 may be executed automatically (e.g., without any further user input) or may be executed manually by a user. Content overlay engine 104 may also be selectively launched, e.g., on a game-by-game basis based on determining that a particular game has been executed, or a game falling within a particular game genre (e.g., sports games) has been executed. In some other implementations, a user of computing device 102 may specify, via a user interface (not shown) one or more video games that cause content overlay engine 104 to be executed concurrently. In some implementations, content overlay engine 104, upon execution, may cause model 108 and/or overlay content 112 to be obtained from one or more remotely located devices (e.g., a cloud-based server or the like) and stored locally on computing device 102, such as in a local storage, cache, and/or volatile memory.

Content overlay engine 104 may be configured as a separate application or process than video game 106 such that content overlay engine 104 is launched and/or terminated without disrupting the execution of video game 106. In other implementations, content overlay engine 104 may be implemented within video game 106 rather than as a separate application or process. Content overlay engine 104 may be configured to provide content as an on-screen overlay (e.g., a graphical or other annotation) displayed in a superimposed manner on one or more video frames generated by video game 106. For instance, as will be described in greater detail below, display 316 may be configured to display overlay content 112 on one or more elements identified in a video frame of video game 106 as on-screen overlays to the frame of the video game.

In step 204, a video frame generated by the video game is obtained. For instance, with reference to FIG. 3, element recognizer 302 may be configured to obtain 322 a video frame of video game 106. In examples, element recognizer 302 may obtain the video frame in real-time, such as during an actual gameplay session of video game 106. The video frame may comprise any format, including but not limited to a still image, bitmap file, jpeg file, portable network graphics (png) file, etc. In other implementations, element recognizer 302 may identify elements in a plurality of video frames generated by video game 116 (e.g., a stream of video frames).

In some instances, each video frame generated by video game 106 may be routed through content overlay engine 104 prior to display on display 316. In other words, content overlay engine 104 may be implemented in manner such that video frames generated by video game 106 are intercepted. In some other instances, however, video game 106 may provide video frames to display 316 for presentation to a user in real-time, while simultaneously or nearly-simultaneously providing video frames to element recognizer 302 such that content overlay engine 104 may provide information stored in overlay content 112 as an overlay to the video frame received by display 316.

In step 206, an element of the video game is identified in the video frame. For instance, with reference to FIG. 3, element recognizer 302 may be configured to identify an element in the video frame obtained from video game 106. Identified elements may comprise any on-screen object in the video frame. For instance, identified elements may include moving objects, stationary objects, landscapes, fields or courts, roadways, etc. Examples of such objects may include, but are not limited to balls, sports equipment, uniforms, vehicles, geographic objects (e.g., bodies of water, mountains, etc.), billboards, trees or other vegetation, etc. These examples are illustrative only, and elements in accordance with implementations described herein may include any object that may be present and/or identifiable in a video frame.

Element recognizer 302 may be configured to identify elements in the obtained video frame in various ways. In some example implementations, element recognizer 302 may be configured to apply 338 model 108, which may comprise a machine learning-based model to identify elements in the video frame, as will be described in greater detail below. In some instances, element recognizer 302 may identify (e.g., search) for elements in a video frame using any suitable image analysis algorithm, OCR algorithm, or any other technique (or combination thereof) as appreciated and understood by those skilled in the art to locate and/or identify on-screen objects.

For instance, element recognizer 302 may be configured to parse the obtained video frame to identify one or more on-screen elements that may be present, such as a ball, a billboard, a vehicle, etc. Because element recognizer 302 is executed concurrently with video game 106, identification of such elements on a video frame of the video game may be performed in real-time or near real-time as the generation of the video frame.

In some implementations, element recognizer 302 may also be configured to identify a location of the identified element. For instance, a location of an identified element may be based on a relative or virtual location on the image frame, such as a location on an image frame using one or more coordinates (e.g., pixel coordinates) representing the location of the identified element in the frame. Element recognizer 302 may identify a center of the identified object on the video frame, or identify a plurality of coordinates representing an outline or a boundary of the identified object.

In yet another implementation, element recognizer 302 may also be configured to identify an element type. For instance, the type of the element may include a category or genre associated with the element. For instance, a rectangular object identified on the rear of a vehicle may be associated with a “license place” element type. In another example, a rectangular outline appearing on the side of a highway may be associated with a “billboard” element type. In yet another example, a sports player's clothing may be associated with a “uniform” element type. These examples are not intended to be limiting, and may include any other type of elements that may serve to categorize the identified element or elements in the obtained video frame.

In some example implementations, element recognizer 302 may also determine a confidence value associated with an identified element. For instance, element recognizer 302 may analyze a video frame to identify an in-game element as described herein and further calculate a measure of confidence associated with the identification. In implementations, if the confidence value is above a threshold, the identified element may be tagged as an element in the video frame that is potentially renderable with an overlay. If the confidence value is below a threshold, the identified element may be tagged as an element that is not renderable (e.g., due to a low confidence). Such a confidence threshold may be configured in any suitable manner, including a user input (e.g., by setting a higher confidence threshold to minimize the likelihood of an inaccurate detection).

In step 208, it is determined whether an overlay is renderable on the element. For instance, with reference to FIG. 3, renderability determiner 304 may be configured to obtain 324 an identification of the element in the video frame and determine whether content, such as information stored in overlay content 112, may be rendered on the element. In some implementations, the determination of whether an overlay may be rendered on an element may be performed by applying 340 model 108 or any other machine learning-based model.

In examples, renderability determiner 304 may determine whether an overlay is renderable in various ways. For instance, renderability determiner 304 may determine that an overlay is renderable based on characteristics associated with the identified element, such as size of the element (e.g., based on a number of pixels), a shape of the element, a location of the element in the video frame, a visibility of the element (e.g., whether the element is obstructed from view or likely to be obstructed), a rate of movement of the element compared to one or more previous video frames, etc. In some other examples, renderability determiner 304 may determine that an overlay is renderable based on a length of time the element is likely to appear during gameplay (e.g., based on a number of video frames in which the element is expected to appear) based on one or more previous executions of the same video game by the same user, a different user, or a group of users.

In yet some other examples, renderability determiner 304 may determine that an overlay is renderable based on whether the overlay may be rendered in a manner that is seamless and/or not intrusive to a user (e.g., in a manner that does not affect the gameplay). For instance, renderability determiner 304 may determine a confidence value relating to a confidence that an overlay may be rendered on the element in a satisfactory and/or non-intrusive manner (e.g., sufficiently large, clear, legible, etc.). Where the confidence value is above a threshold value, the overlay may be rendered, and where the confidence value is not above the threshold value, the overlay may not be rendered. As an illustrative example, a race track or highway in a racing game may comprise a low confidence value because the high movement rate of the road would result in an overlay that is not displayed for a sufficient period of time, with an adequate clarity, and/or may hinder a user's gameplay. In contrast, a license plate on a vehicle traveling along the road may comprise a high confidence value because the license plate may appear during gameplay for an extended period of time and may not move significantly in subsequent frames. These examples are illustrative only, and may include any other manner of determining whether an overlay is suitable for rendering on an element of a video frame. Thus, in examples, renderability determiner 304 may be configured to identify surfaces within the obtained video frame that are suitable for rendering additional content for presentation to a user during gameplay.

In step 210, the content is overlaid on the element in the video frame. For instance, with reference to FIG. 3, content renderer 306 may be configured to obtain 326 an indication that an element is renderable and overlay content (e.g., information stored in overlay content 112) on the identified element in the video frame. As described above, the overlaid content may comprise any type of information, including but not limited to advertisements, logos, alphanumeric text, etc. Examples of overlaying advertisements onto elements of video frames will be described in greater detail below with respect to FIG. 5.

In some implementations, content renderer 306 may be configured to select 328 a particular item of content for overlaying on the element identified in the image frame. For instance, content renderer 306 may select an item of content stored in overlay content 112 corresponding to the type of element identified in the video frame. In some example embodiments, content renderer 306 may select the content for overlaying based at least on one or more user preferences. For example, a user may interact with a graphical user interface (GUI) or any other suitable interface (e.g., via voice commands, etc.) of computing device 102 to configure one or more user preferences in user account 320 associated with the user. In some implementations, user preferences stored in user account 320 may be performed during an initial or one-time configuration of content overlay engine 104. In other implementations, user preferences may be configured for each video game in which content overlays may appear.

User preferences stored in user account 320 may include, but are not limited to, user preferences relating to subject matter (e.g., content that the user likes and/or dislikes), how often content should be overlaid (e.g., a frequency at which content may be overlaid on elements), a length of time content should be overlaid on elements, sizing of overlaid content, particular content sources that the user enjoys or dislikes (e.g., particular advertisers, developers, etc.), and/or any other user profile information (e.g., a user location, preferred game titles and/or game genres, products and/or brands that the user prefers, etc.). In examples, user account 320 may be stored local to computing device 102, may be stored remotely (e.g., on a cloud-based server), and/or may be imported from any other service in which user profile information may be stored (e.g., a social media profile).

In an illustrative example, video game 106 may comprise a racing game. Element recognizer 302 may identify a plurality of elements in one or more video frames in accordance with techniques described herein, such as a vehicle, a driver's helmet, a billboard, and a racetrack. Element recognizer 302 may also be configured to identify element types for each identified element. In this illustrative example, the vehicle may comprise an “automobile” element type, the helmet may comprise a “driving accessory” element type, the billboard may comprise a “billboard advertisement” element type, and a racetrack may comprise a “roadway” element type. Based on various factors, such as application of model 108, the user's gameplay session of video game 106, and/or user information stored in user account 320, renderer determiner 304 may determine that the vehicle, driver's helmet, and billboard comprise renderable surfaces, while the racetrack is not a renderable surface. Content renderer 306 may obtain a particular item of content for each renderable surface corresponding to the element type (e.g., an advertisement for a car repair shop in the form of a decal to be overlaid on the vehicle, an advertisement in the form of a sticker to be overlaid on the helmet, and an advertisement in the form of a large poster to be overlaid on the billboard). Because the overlaid content may comprise high-fidelity images and/or videos in some implementations (e.g., a quality that may be similar to, or exceed, the quality of the image frame), content renderer 306 may overlay the content in a manner that results in the overlaid content being a part of video game 106 itself, resulting in a seamless appearance.

If renderability determiner 304 determines that a license plate identified in a racing game is a surface of the video frame that may be overlaid with content, content renderer 306 may select an item of content matching the element type for the element in accordance with one or more preferences stored in user account 320, such as by selecting an item of content that comprises a sports drink advertisement because user account 320 indicated a preference for sports (or beverages) for overlaying on the license plate. Thus, when content renderer 306 is rendering an overlay on an image frame, an item of content may be dynamically selected for the overlay that is tailored for the user of computing device 102.

The overlaid content may be presented 334 for presentation on display 316 in various ways. As described above, in some example embodiments, element recognizer 302 may be configured to intercept each video frame generated by video game 106, such that display 316 is configured to display video frames received from content overlay engine 104. In other words, instead of video game 106 transmitting video frames to a graphics processing unit (GPU) for presentation in display 316, element recognizer 302 may intercept such frames prior to transmission to the GPU. In such examples, if renderability determiner 304 determines that the element should be overlaid with certain content, content renderer 306 may generate a new video frame that supplements the obtained video frame with the overlaid content (e.g., by replacing the element with modified pixels corresponding to the overlaid content), and transmit the new video frame to the GPU for subsequent presentation on display 316. In some further implementations, content renderer 306 may also be configured to blend the content overlay at the location of the identified element in the image frame to improve its seamlessness. In instances where an overlay is not to be rendered, the video frame obtained from video game 106 may be transmitted to the GPU without modification.

In some other example embodiments, however, the GPU may be configured to receive the video frame from video game 106, while also receiving the overlay content from content renderer 306 that is to be overlaid on the video frame. For instance, content renderer 306 may be configured to transmit the overlay content to the GPU (e.g., instead of the entire video frame), along with overlay rendering instructions (e.g., a size of the overlay, a location of the overlay, blending characteristics, etc.) such that the GPU may overlay the content when rendering the video frame on display 316. In such examples, content renderer 306 may transmit the overlay as one or more image files, such as image files comprising a transparent channel (e.g., an alpha channel) to enable the overlay to be rendered seamlessly.

In some examples, content renderer 306 may be configured to render an overlay on the identified element for a predetermined time period, a predetermined or minimum number of video frames (e.g., based on a length parameter associated with an item of content), based on a user preference, and/or until the element is no longer visible in the gameplay. Content overlay engine 104 may be configured to process each video frame generated by video game 106 as described herein to render such an overlay over successive frames (e.g., obtaining the video frame, identifying an element in the video frame, determining if an overlay may be rendered, and rendering an appropriate overlay). In other examples, content renderer 306 may be configured to overlay content on the same element in successive video frames by tracking a movement of the identified element in successive video frames using any suitable object recognition and/or object tracking algorithm. In this manner, an overlay may be rendered across multiple (e.g., successive) video frames with reduced processing, thereby improving the efficiency of content overlay engine 104 in some examples.

In some example embodiments, content renderer 306 may also be configured to provide overlays during gameplay of video game 106 in accordance with one or more user preferences. For instance, content renderer 306 may provide content overlays comprising advertisements during the course of an entire video game, provide content overlays for a minimum or maximum time period, provide content overlays that continuously change throughout a gameplay session, or any other user preference that may be stored in user account 320.

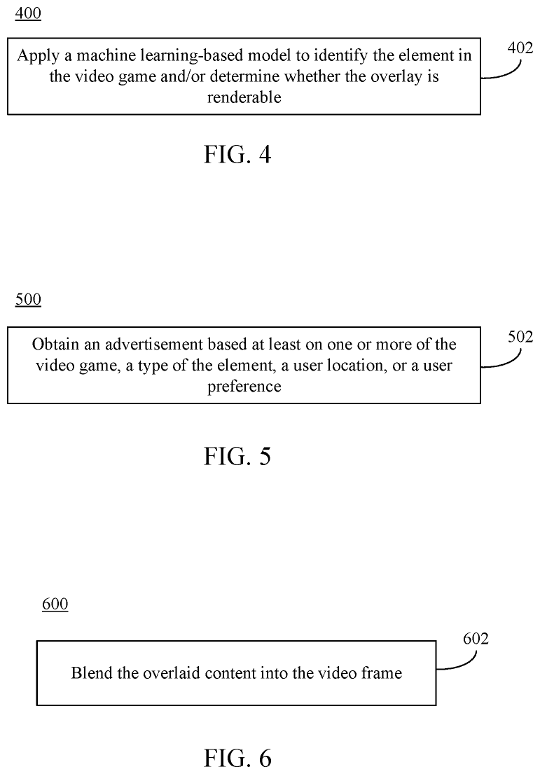

As described above, in examples, content overlay engine 104 may utilize a machine learning-based model to identify an element in a video frame and/or determine whether an overlay may be rendered over an element. For instance, FIG. 4 shows a flowchart 400 of a method for applying a video game model, according to an example embodiment. In an example, the method of flowchart 400 may be implemented by element recognizer 302, renderability determiner 304, and/or model 108, as shown in FIG. 3. Other structural and operational implementations will be apparent to persons skilled in the relevant art(s) based on the following discussion regarding flowchart 400.

Flowchart 400 begins with step 402. In step 402, a machine learning-based model is applied to identify the element in the video game and/or determine whether the overlay is renderable. For instance, with reference to FIG. 3, element recognizer 302 may be configured to apply model 108, which may comprise a machine learning-based model, to identify an on-screen element in the video frame of the video game. In some other implementations, renderability determiner 304 may apply model 108 to determine whether an overlay is renderable on the identified element. Each of these examples are described in greater detail as follows. In implementations, video game model generator 314 may be implemented on one or more servers communicatively coupled to computing device 102 via a network interface and be configured to generate and train model 108 (or a plurality of models) that is deployed (e.g., via the Internet or any other network) to computing device 102. In some implementations, model 108 (or a plurality of models) may be deployed to a plurality of computing devices that may execute video game 106.

As described, element recognizer 302 may apply model 108 to identify elements of the video game. Video game model generator 314 may be configured to generate model 108 for each video game and/or each category (e.g., genre) of video games. For example, model 108 may comprise a game specific model that may comprise an identification of the various game objects that may appear to a user during gameplay for a particular game. For instance, video game model generator 314 may generate model 108, e.g., based on a plurality of prior executions of a particular video game or category of video games, that certain objects (e.g., vehicles, license plates, roadways, billboards, landscapes, etc.) may appear during gameplay. In such examples, element recognizer 302 may be configured to apply model 108 to identify game elements present in a video frame obtained during an actual gameplay through one or more machine learning techniques, including but not limited to correlation, similarity metrics, etc.

Accordingly, video game model generator 314 may generate model 108 that associates element tags (e.g., labels) with elements of video game 106. In implementations, model 108 may comprise a machine-learning based model for each video game that may be trained in a number of ways, including both supervised and unsupervised training, as will be described in greater detail below. As video game 106 is played more, model 108 may obtain additional training data, thus enhancing the accuracy of model 108 over time. In an example, element recognizer 302 may apply model 108 to associate a particular graphical object (e.g., a sports jersey, a rectangular outline on the rear of a vehicle, etc.) with an element tag (e.g., a player uniform, a license plate, etc.). In another example, video game model may associate other graphical objects, such as shapes and/or colors that resemble landscaping with an appropriate element tag. As described above, model 108 may comprise a machine learning-based model for each different video game 106. For instance, because video games may comprise different content, video model 108 may comprise a unique association of element tags to video game elements for each video game 106. However, examples are not limited to this implementation, and may also include applying the same model for a plurality of different video game titles. For instance, different video game titles corresponding to the same sports genre (e.g., basketball) may similar in-game elements, and therefore the same model 108 may be utilized in such examples.

Accordingly, upon obtaining a video frame from video game 106, element recognizer 302 may apply model 108 to identify elements present during an actual gameplay. For instance, element recognizer 302 may apply model 108 to identify any one or more on-screen elements in the video frame, such as a player jersey, a vehicle, a roadway, a billboard, a field, etc. Because element recognizer 302 is executed concurrently with video game 106, identification of such elements on a video frame of the video game may be performed in real-time or near real-time.

As described earlier, renderability determiner 304 may also apply model 108 to determine whether an overlay is renderable on the identified element. For instance, renderability determiner 304 may apply model 108 to determine whether an element identified in a video frame meets certain characteristics suitable for rendering an overlay thereon. In example embodiments, model 108 may be applied to determine whether the element is likely to be present in the gameplay for a sufficient time period (e.g., a threshold number of video frames) based on a plurality of prior executions of the same video game. As an illustrative example, while element recognizer 302 may identify a roadway as an element in a video frame, renderability determiner 304 may apply model 108 to determine that the roadway is a transient object based on prior executions of video game 106, and therefore the roadway is not suitable for rendering an overlay thereon. In another illustrative example, renderability determiner 304 may apply model 108 to determine that a license plate of a vehicle driving on the roadway typically remains visible during gameplay for a sufficient number of video frames based on prior executions, and therefore, the license plate is an element which may be overlaid with additional content.

In yet some other examples, features relating to the identified element may be provided as an input to model 108 to determine whether the element should be rendered with an overlay. For instance, based on the identification of the element by element recognizer 302, features of the element (e.g., how long the element appears during gameplay, the rate of movement of the element, etc.) may be applied to model 108 to determine whether the element should be rendered with an overlay. In some examples, such characteristics may be weighted in various ways such that model 108 may indicate that elements associated with certain feature sets may be rendered with an overlay, while elements with other feature sets are not suitable for rendering with an overlay.

In some other examples, renderability determiner 304 may apply model 108 to determine other characteristics associated with a particular identified object based one or more prior executions of the same video game, such a visibility of the element (e.g., whether the size and/or clarity of the element is sufficient for rendering), a rate of movement of the element, a location of the element during gameplay (e.g., whether the element is likely to be at the edge of the screen or closer to the center of the screen), etc. These examples are intended to be illustrative only, and renderability determiner 304 may apply model 108 to determine any factor relating to whether a user of video game 106 is likely see an overlay on the element in the video frame (e.g., in the field of view of the user).

In some further example embodiments, model 108 may be based on a single user or a group of users of video game 106. For instance, because users may interact with video game 106 differently (e.g., some users may perform better or navigate through a game in a different manner), model 108 may be personalized such that renderability determiner 304 may determine that an element in a video frame may be renderable with an overlay for one user, while the same element may not be renderable with an overlay for a different user of the same video game. For instance, if video game 106 comprises a racing game that includes various billboards on the side of a roadway, video game model generator 314 may train model 108 for the first user based on the first user's performance in the video game, and train model 108 for the second user based on the second user's performance in the video game. In an example, if the performance of the first user is substantially better than the second user (e.g., the first user does not drive off the roadway or crash into billboards, etc.), billboards may be identified as a renderable element for the first user, while the same billboards may not be renderable for the second user.

In other examples, poor performance (or any other manner of playing video game 106) may be utilized as a factor in determining whether to render content overlays on one or more elements of a video game. For instance, if a particular user (or a plurality of users) perform poorly in a video game (or parts of a video game) based on prior executions of the video game, renderability determiner 304 may determine that content overlays should not be rendered on the elements of the video game that may result in a distraction to the video game player. As described above, however, model 108 may also be applied to determine whether an element is renderable with an overlay based on learned behaviors from a plurality of users of video game 106 (e.g., based on all users of video game 106 collectively, and/or users of video game 106 in a particular geographic region, age group, skill level, etc.).

In implementations, model 108 may be pre-trained and/or may be trained on-the-fly (e.g., during gameplay), or a combination of both such that model 108 is configured to continuously learn 342 the behaviors of in-game elements of video game 106 based on a single user and/or a plurality of users. For instance, as video game 106 is being played by one or more users, model 108 may be trained based on characteristics associated with elements appearing during gameplay, such as the length of time various elements may appear, the size of such elements, the location (including but not limited to a position and/or orientation) of such elements on a video frame a whole and/or the location of an element with respect to one or more other elements, the rate of movement of such elements, the skill level of the video game player, etc. Renderability determiner 304 may apply model 108 with any combination and/or weights associated with such characteristics to determine whether an overlay may be rendered on an element. For instance, renderability determiner 304 may determine to render (or not render) an overlay over a particular element identified in a video frame that appears at a location that is considered to have (or not have) strategic importance to a user or group of users or otherwise identified as important (or unimportant). In this manner, renderability determiner 304 may apply model 108 to determine that users with certain characteristics (e.g., skill levels or other characteristics associated with the users' gameplay behaviors) are likely to interact with video game 106 in a manner that results in certain in-game elements being displayed longer, larger, etc. In a further example, model 108 may also be trained 336 based on the manner (e.g., size, location, length of time, etc.) that one or more previous content overlays were presented on elements of video game 106. As a result, model 108 may also be trained based on previously overlaid content.

In some examples, model 108 may be trained using one or more supervised and/or unsupervised learning algorithms as appreciated by those skilled in the art. Supervised training may include training model 108 based on one or more user inputs. In one implementation, user(s) may train model 108 by manually associating a renderability label with an element of video game 106. For example, a user may identify a particular element (e.g., a player uniform, a billboard, a license plate, etc.) of a video frame of video game 106 as renderable with an overlay. Such training may be performed via any suitable user input, such as a touchscreen, keyboard, voice input, pointing device, etc. It is noted that example embodiments are not limited to training model 108 based on a single user input. Rather, model 108 be trained based on any number of users, such as a player currently playing or viewing video game 106.

Although it is described herein that element recognizer 302 and/or renderability determiner 304 may apply a single model 108, it is understood that embodiments are not limited to a single machine-learning model. For example, model 108 may comprise a plurality of machine learning-based models that may be obtained and/or applied by computing device 102 via a network interface or the like, a subset of which may be applied by element recognizer 302, and another subset which may be applied by renderability determiner 304. Accordingly, any number of machine learning-based models may be implemented in accordance with techniques described herein.

As described above, a designer (e.g., a game designer or publisher, a content overlay designer, etc.) may also train model 108 through any suitable method of supervised training as discussed herein or through one or more other methods. In some further implementations, however, video game 106 may also comprise one or more pre-tagged elements (e.g., in-game objects or surfaces) that may be renderable with content overlays. For example, a designer may identify a plurality of elements in video game 106 along with an indication that such elements comprise renderable surfaces. In this manner, because objects which may be rendered with overlays have been previously identified for video game 106, renderability determiner 304 may be configured to operate more efficiently during gameplay, thereby further speeding up the rate at which content may be overlaid on elements of a video frame.

In other implementations, model 108 may be trained based on unsupervised training. For instance, video game model generator 314 may be configured to obtain a plurality of graphics, e.g., from an online or offline element repository or the like, that may identify examples of elements that are renderable such that model 108 may be trained automatically. For example, an element repository (e.g., existing on the cloud or other remotely located device or server(s)) may be used to map in-game elements (e.g., images or graphics resembling such elements) to one or more text-based labels, such as element types and/or a label indicating whether the element may be renderable with an overlay. For instance, elements of a video game (e.g., clothing, license plates, billboards, etc.) may be automatically mapped to a corresponding element type and/or renderability label based on information obtained from an element repository.

In other examples, model 108 may be trained based on features of in-game elements that may be used to determine whether an element is renderable with an overlay, such as features that identify how long an element may be visible during gameplay, how large the element appears, or any other characteristic relating to the overall visibility of an in-game element during gameplay. In other examples, model 108 may learn that certain elements are renderable automatically during gameplay based on one or more features described herein (e.g., relating to the visibility of the element).

In yet another implementation, model 108 may be trained based on one or more other video games. For example, where a model 108 for a particular video game identifies an element as renderable (e.g., based on features of the element), model 108 may be trained to identify similar elements (and features thereof) in different games based on the trained characteristics.

Accordingly, model 108 be trained based on supervised training or unsupervised training as discussed above. It is noted that model 108 may also be trained based on a combination of supervised and unsupervised training. For instance, certain elements of a video game may be manually labeled as renderable, while model 108 may be trained to associate identify other elements as renderable in an unsupervised manner. Model 108 may be generated and/or stored remotely, such as on one or more cloud-based servers and subsequently transmitted to computing device 102 prior to or during execution of content overlay engine 104. In other implementations, model 108 may be generated and/or stored locally (e.g., on computing device 102).

As described above, content renderer 306 may be configured to overlay an advertisement on an element of a video frame. For instance, FIG. 5 shows a flowchart 500 of a method for obtaining an advertisement, according to an example embodiment, according to an example embodiment. In an example, the method of flowchart 500 may be implemented by advertisement obtainer 308, as shown in FIG. 3. Other structural and operational implementations will be apparent to persons skilled in the relevant art(s) based on the following discussion regarding flowchart 500.

Flowchart 500 begins with step 502. In step 502, an advertisement is obtained based at least on one or more of the video game, a type of the element identified in the video frame of the video game, a user location, or a user preference. For instance, with reference to FIG. 3, advertisement obtainer 308 may be configured to obtain 344 an advertisement stored in overlay content 112 (which may contain overlay content stored in a database stored locally and/or a database stored on a remote computing device) based at least on one or more factors, including but not limited to a title of video game 106, the type of element for which an overlay is determined to be renderable, a location of a user of computing device 102 (e.g., a geographic location), a user preference (e.g., obtained 348 from user account 320), or any other factor or combination thereof. In some example implementations, advertisement obtainer 308 may pre-fetch one or more advertisements from a remotely located content source (e.g., a computing device that may include overlay content 112) store such advertisements in advertisement cache 310 when video game 106 is executed. For instance, model 108 may identify one or more types of in-game elements (e.g., license plates, billboards, etc.) that may later appear in video frames of video game 106, and advertisement obtainer 308 may accordingly pre-fetch such ads once video game 106 is launched. In this manner, when content renderer 306 determines that an advertisement will be rendered on a particular element of a video frame, advertisement obtainer 308 may obtain 346 a suitable advertisement from advertisement cache 310 to further reduce delays in rendering content on the element. In some other examples, however, advertisement obtainer 308 may obtain advertisements directly from one or more remote content sources in real-time for rendering, and/or continuously pre-fetch advertisements for storage in advertisement cache 310.

As described above, advertisement obtainer may obtain one or more advertisements corresponding to a particular video game upon execution of video game 106, such as a vehicle-related advertisement where video game 106 comprise a racing game, or a beverage advertisement where video game 106 comprises a sports game. For instances, advertisements obtained from overlay content 112 and/or advertisement cache 310 may be associated with a game type or genre that advertisement obtainer 308 may use to obtain an appropriate advertisement or advertisements for rendering on in-game elements.

In some other examples, advertisement obtainer 308 may obtain an advertisement based on a type of the element identified in the video frame of the video game. For instance, different advertisements may be selected based on which type of element the advertisement will be overlaid. In one illustrative example, an advertisement selected for a license plate may comprise an advertiser's company logo due to a relatively small dimension of a license plate in a video frame, while an advertisement for a billboard in the same video game may comprise different or additional content, such as a company logo, a slogan, a picture of an advertised product, etc.

In yet some other examples, a type of the element may also be used to determine what form of advertisement may be overlaid. For instance, if the type of element is a billboard or a banner on a soccer field that comprises a slower rate of movement relative to other elements in the video frame, advertisement obtainer 308 may obtain an advertisement that comprises a video advertisement. The video advertisement may comprise a suitable video format (e.g., .MP4, .3GP, .OGG, .WMV, .MOV, .AVI, etc.), and/or may comprise a sequence of image files (e.g., .JPG, .TIF, .BMP, .PNG, RGB image files, etc.) as appreciated by those skilled in the relevant arts. If a video advertisement is selected, content renderer 306 may overlay the video advertisement on the element a series of video frames for presentation in display 316 in a similar manner as described herein. For instance, content renderer 306 may render the video advertisement to match a frame rate of the video game (e.g., by slowing down or speeding up the obtained advertisement as needed). As a result, content renderer 306 may overlay both still images and/or video images in a seamless manner.

In another implementation as described above, advertisement obtainer 308 may select an advertisement based on a user location. For instance, advertisements (e.g., local advertisements) may be selected based on the user's geographic location. In this manner, content that may be more suitable for a particular user of computing device may be dynamically presented to the user based on the user's location, such local restaurants, dealerships, gyms, etc.

In yet another implementation, advertisement obtainer 308 may obtain advertisements in accordance with one or more user preferences stored in user account 320. For instance, user account 320 may comprise preferences that indicate that a particular user prefers or dislikes certain advertisement categories (e.g., entertainment, news, food, etc.), forms of advertisements, brands, genres, etc. In some other implementations, user preferences stored in user account 320 may also indicate particular game elements or types of game elements for which the user prefers or does not prefer to see advertisements. It is understood and appreciated that any other user preference may be utilized as described herein to match obtained advertisements to user preferences to further enhance a user's experience while playing or viewing video game 106.

It is also noted and understood that although examples are described where advertisement obtainer 308 may be configured to obtain advertisements for overlaying on in-game elements, implementations are not limited to advertisements and may include obtaining any other content for overlaying on an in-game element of a video frame in real-time. For example, advertisement obtainer 308 may be configured to obtain content made available by other video game players (e.g., to view game streams of that video game player), content provided by developers of video game 106 and/or third party game developers or game studios (e.g., to identify or advertise new game versions, releases, downloadable or purchasable game content, etc.), content that may be overlaid on in-game elements to change an appearance of the in-game element (e.g., to overlay a different team uniform, overlay a different car shape or logo on a vehicle, etc.), or other type of content that may be overlaid on any element of video game 106. Furthermore, overlay content 112 and/or advertisement cache 310 are not limited to containing information from a content source or repository, but may contain information obtained from a plurality of different content sources (e.g., a plurality of advertisement platforms, content from various game developers, etc.).

In examples, content renderer 306 may be configured to overlay content on an element of a video frame in various ways. For instance, FIG. 6 shows a flowchart 600 of a method for blending overlaid content into a video frame, according to an example embodiment. In an example, the method of flowchart 600 may be implemented by content renderer 306, as shown in FIG. 3. Other structural and operational implementations will be apparent to persons skilled in the relevant art(s) based on the following discussion regarding flowchart 600.

Flowchart 600 begins with step 602. In step 602, overlaid content is blended into the video frame of the video game. For instance, with reference to FIG. 3, content renderer 306 may be configured to blend the overlaid content (e.g., an advertisement selected based on any one or more factors described herein) onto an element of the video frame for presentation on display 316. Content renderer 306 may blend the overlaid content in various ways. For instance, where the overlaid content comprises a video, content renderer 306 may match a framerate of the overlaid content to a framerate of the video game. In other examples, content renderer 306 may alter one or more colors and/or sharpness characteristics, such as by modifying colors appearing on the edges of the overlaid content and/or the element on which the content is overlaid, blurring the overlaid content and/or the element on which the content is overlaid, and/or a combination thereof. In some other examples, overlaid content may be blended by optimizing, stretching, enlarging, shrinking, and/or skewing the overlaid content to fit a shape and/or size of the element on which the content is overlaid. Furthermore, content renderer 306 may also be configured to perform such blending operations in a dynamic manner with each subsequent video frame in which the overlaid content appears, such as by modifying the overlaid content to account for a different element shape or size (e.g., where the game player's perspective changes), or account for any other game characteristics in real-time that may affect the appearance of the overlaid content, such as shadows, that may change between successive frames.

Content renderer 306 is not limited to the aforementioned blending techniques, and may also implement any one or more other image processing and/or modification techniques to blend overlaid content onto an image frame (or a sequence of image frames) as appreciated by those skilled in the art. In this manner, content renderer 306 may overlay content that is dynamic and seamless such that the overlaid content may appear in the video frame as part of video game 106 itself.

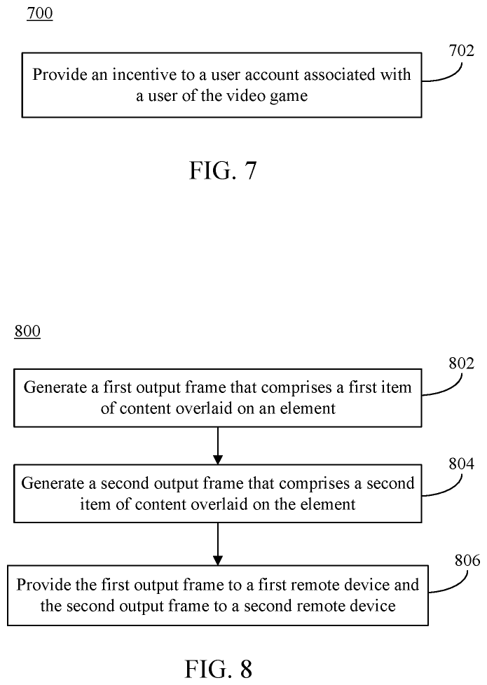

In examples, content overlay engine 104 may also provide one or more incentives to a user of computing device 102 based at least on the overlaid content. For instance, FIG. 7 shows a flowchart 700 of a method for providing an incentive to a user account, according to an example embodiment. In an example, the method of flowchart 700 may be implemented by incentive provider 312, as shown in FIG. 3. Other structural and operational implementations will be apparent to persons skilled in the relevant art(s) based on the following discussion regarding flowchart 700.

Flowchart 700 begins with step 702. In step 702, an incentive is provided to a user account associated with a user of the video game. For instance, with reference to FIG. 3, incentive provider 312 may be configured to provide one or more incentives to user account 320 associated with a user of computing device 102 (e.g., a user playing and/or viewing video game 106). Incentives may include any type of reward, such as a monetary award (e.g., a real currency, cryptocurrency, and/or virtual or game-based currency), a game credit, a game achievement, a game token, or any other type of offering that may incentivize an owner of user account 320 to continue to play video game 106, purchase additional content, become reimbursed for video game 106.

Incentive provider 312 may provide incentives to user account 320 in various ways. In one example, incentive provider 312 may obtain 330 one or more metrics associated with overlaid content during gameplay of video game 106 and provide 332 incentives based on the overlaid content (e.g., advertisements). For instance, incentive provider 312 may provide incentives based on a quantity of items of content overlaid on elements of video game 106, a length of time (individually and/or collectively) items of content were overlaid during gameplay, a sizing of items of content overlaid, etc. In some examples, incentive provider 312 may reimburse the cost of video game 106 purchased by a user (and/or other video games that may be purchased in the future) by providing monetary incentives to user account 320 when items of content are overlaid. In some other examples, video game 106 may comprise an advertisement-enabled version of a video game (e.g., purchased at a subsidized cost via a game subscription, from an online store, from a retail store, etc.), which when launched, may comprise content overlays as described herein.

In the above manner, an enhanced level of interaction may be provided to a player or viewer of video game 106 by incentivizing users to continue to play the game and obtain rewards. In other words, incentive provider 312 may enable users of computing device 102 to obtain benefits from playing or viewing video games (e.g., through reimbursement or subsidization or the like) while also enabling content providers, such as advertisers, to advertise context-specific products or services in a dynamic, non-intrusive, and seamless manner during gameplay of video game 106.

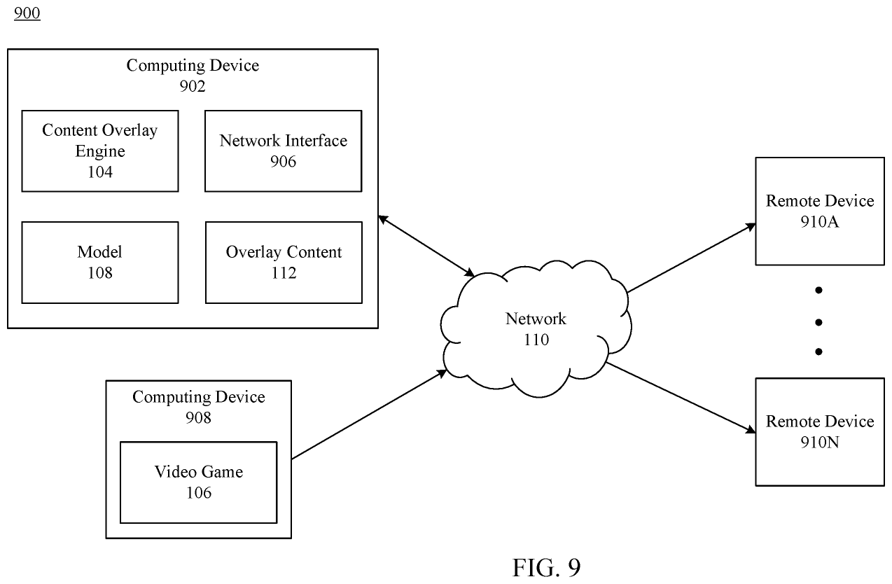

In some implementations, content overlay engine 104 may render different items of content on the same element. For instance, FIG. 8 shows a flowchart 800 of a method for generating a plurality of output frames, according to an example embodiment. In an example, the method of flowchart 800 may be implemented by system 900, as shown in FIG. 9. System 900 comprises a computing device 902, a computing device 908, and remote devices 910A-910N, each of which may be coupled via network 110. As shown in FIG. 9, computing device 902 comprises content overlay engine 104, a network interface 906, model 108, and overlay content 112. Computing device 908 may be configured to execute video game 106. For example, in the illustration shown in FIG. 9, video game 106 may be executed on one computing device, while one or more remote viewers (e.g., users of remote devices 910A-910N) may view or stream a real-time execution of the video game via network 110. Other structural and operational implementations will be apparent to persons skilled in the relevant art(s) based on the following discussion regarding flowchart 800 and system 900.

Flowchart 800 begins with step 802. In step 802, a first output frame is generated that comprises a first item of content overlaid on an element. For instance, content overlay engine 104 of computing device 902 may be configured to generate a first output frame that comprises a first item of content overlaid on an element of a video frame of video game 106. In the example embodiment shown in FIG. 9, computing device 902 may comprise a server (e.g., a cloud-based server or the like) configured to obtain video frames representing the real-time gameplay of video game 106 via network interface 960 coupled to network 110. In implementations, computing device 902 may provide, via network interface 906, real-time video game content to one or more remotely located devices, such as remote devices 910A-910N. In other words, users of remote devices 910A-910N may access an execution of video game 106 to view a gameplay session in real-time or near real-time.

Network 110, as described previously with reference to FIG. 3, may comprise one or more networks that may couple computing device 902, computing device 908, and remote devices 910A-910N. In examples, computing device 902, computing device 908, and remote devices 910A-910N may communicate via one or more APIs. Computing device 908 may be a device configured to output a video signal comprising one or more video frames to a display screen (not shown). Computing device 908 may comprise a video game console (e.g., a Microsoft Xbox® of any version, a Sony Play Station® of any version, A Nintendo Wii®, NES, or Switch™ of any version, etc.), a desktop computer, a portable computer, a smartphone, a tablet, a wearable computing device, a head mounted gaming device, a mixed and/or virtual reality device (e.g., Microsoft HoloLens™), or any other processing device for executing a video game and outputting video frames generated by the video game to a display device. An example computing device that may incorporate the functionality of computing device 908 is discussed below in reference to FIG. 11.

As shown in FIG. 1, content overlay engine 104 of computing device 902 is configured to obtain video frames of video game 106 via network interface 906 and provide an overlay on one or more of the obtained video frames. For example, content overlay engine 104 may provide one or more content overlays comprising an advertisement or any other content to one or more remotely located devices coupled to network 110. In implementations, content overlay engine 104 may be similar to content overlay engine 104 described previously, and may be executed concurrently with video game 106 such that content overlay engine 104 may overlay content on video frames generated during gameplay of video game 106 in real-time. For example, content overlay engine 104 may be configured as an application executing on a server or the like that may be executed concurrently with video game 106.

In some example implementations, network interface 906 may comprise one or more plugins configured to interact with remote devices 910A-910N that enable remotely-located users to view and/or stream the real-time gameplay of video game 106 over a network. In some implementations, such plugins may correspond to communication channels for communicating with an online or cloud-based service provided by one or more servers (not shown). For instance, such plugs may enable content overlay engine 104 to connect to a plurality of different gaming services that allow remote viewers (e.g., users of remote devices 910A-910N) connected to the same gaming services to interact with a video game player of video game 106. Some examples include interactive gaming services such as Discord® developed by Discord, Inc. of San Francisco, Calif., Twitch® developed by Twitch Interactive, Inc. of San Francisco, Calif., and Mixer™ developed by Microsoft Corporation of Redmond, Wash. It is noted that content overlay engine 104 is not limited to communicating with remote devices via one or more plugins. For instance, in other implementations, content overlay engine 104 may include any other manner for communicating with another device over network 110, such as via standalone software executed on computing device 902, computing device 908, remote devices 910A-910N, one or more APIs, or other software and/or hardware implemented in such devices for enabling real-time interaction between a remote viewer and a player of video game 106. In some other implementations, content overlay engine 104 may communicate with one or more remote devices via any type of direct connection or indirect connection (e.g., through an intermediary such as one or more servers not shown).

Remote devices 910A-910N include one or more remote devices of remote viewers interacting with a user of computing device 908 (e.g., viewing or streaming a real-time gameplay of video game 106). It is to be understood that system 900 may comprise any number of remote devices 910A-910N and each remote device may be located in any one or more locations. Remote devices 910A-910N may comprise a mobile device, including but not limited to a mobile computing device (e.g., a Microsoft® Surface® device, a PDA, a laptop computer, a notebook computer, a tablet computer such as an Apple iPad™, a netbook, etc.), a mobile phone, a handheld video game device, a wearable computing device, a head mounted gaming device, or a mixed and/or virtual reality device (e.g., Microsoft HoloLens™). Remote devices 910A-910N may comprise a stationary device such as but not limited to a desktop computer or PC (personal computer), a video game console, a set-top box, a television, or a smart device, such as a voice-activated home assistant device. In implementations, remote devices 910A-910N may comprise one or more output devices, such as a speaker and/or a display device (not shown) configured to output audio and/or video content representing the real-time gameplay of video game 106. In example embodiments, remote devices 910A-910N may be coupled to content overlay engine 104 via an appropriate plugin to obtain content from computing device 908. In other implementations, remote devices 910A-910N may interface with content overlay engine 104 via network 110 through a suitable API, and/or by other mechanisms, such as a web browser (e.g., Microsoft® Internet Explorer, Google® Chrome, Apple® Safari, etc.). Note that any number of plugins, program interfaces or web browsers may be present. It is also noted and understood that although content overlay engine 104 and network interface 906 are illustrated as implemented in computing device 902 separate from computing device 908, content overlay engine 104 and network interface 906 may be implemented as part of computing device 908 (e.g., executed on the same machine that video game 106 is executed).

Note that the variable “N” is appended to various reference numerals for illustrated components to indicate that the number of such components is variable, with any value of 2 and greater. Note that for each distinct component/reference numeral, the variable “N” has a corresponding value, which may be different for the value of “N” for other components/reference numerals. The value of “N” for any particular component/reference numeral may be less than 10, in the 10s, in the hundreds, in the thousands, or even greater, depending on the particular implementation.

Referring back to step 802 of FIG. 8, element recognizer 302 may be configured to obtain a video frame of video game 106 and identify one or more in-game elements in the video frame in a similar manner as previously described. Similarly, renderability determiner 304 may determine, for each identified element in the video frame, whether content may be rendered as an overlay on the element. In the example of system 800, content renderer 306 may generate a first output video frame that comprises a first item of content, such as a first advertisement obtained by advertisement obtainer 308, overlaid on an identified element in the video frame. Content renderer 306 and advertisement obtainer 308 may be configured to generate the first output frame in a similar manner as described above, such as by selecting an appropriate advertisement stored in overlay content 112 based on a number of factors, including but not limited to the video game, a type of the identified element, a location of a user (e.g., a location of user of computing device 908 and/or a user of one of remote device(s) 910A-910N), a user preference (e.g. a preference of a user of computing device 908 and/or a user of one of remote device(s) 910A-910N), and/or any other factor described herein. In some instances, advertisement obtainer 308 may be configured to select a first advertisement tailored to a user of one of remote devices 910A-910N based on preferences stored in an associated user account as described previously. Based on the selected advertisement, content renderer 306 may generate a first output frame for a user of the remote device.

In step 804, a second output frame is generated that comprises a second item of content overlaid on the element of the video frame generated by the video game. For instance, with continued reference to FIGS. 3 and 9, advertisement obtainer 308 may select a second item of content (e.g., a second advertisement) stored in overlay content 112 and provide the selected item of content to content renderer 306 for generating a second output frame that overlays the second item of content on the same element. In other words, content overlay engine 104 may be configured to generate two distinct output video frames from the same input video frame (i.e., the video frame obtained from video game 106), with each output video frame comprising an item of content that may be matched or tailored to a particular user of a remote device viewing or streaming video game 106.

In some examples, while certain remotely located users may see overlaid content on video frames generated from video game 106, implementations also contemplate determining whether to render overlays for one or more of remote devices 910A-910N based on other factors, such as bandwidth capabilities, local processing resources, and/or user preferences. For instance, where a particular remote device may not comprise a sufficient amount of bandwidth and/or local processing resources, content overlay engine 104 may determine not to render overlays on certain (or any) elements identified in video game 106 to minimize disruptions to the user's viewing experience. In other examples, such as where a user account indicates that a particular user does not prefer to see any overlaid content, content overlay engine 104 may determine not to render overlays on video frames for that particular user. As a result, where real-time video game content is streamed to various remotely located devices, each device may receive overlaid content (or no overlaid content at all) tailored to users of that remote device.

In step 806, the first output frame is provided to a first remote device and the second output frame is provided to a second remote device. For instance, with reference to FIG. 9, network interface 906 may be configured to provide the first output frame comprising the first item of content to a first one of remote devices 910A-910N, and a second output frame comprising the second item of content to a second one of remote devices 910A-910N.

In one illustrative example, a user of computing device 908 may launch a sports video game (e.g., a soccer game) comprising a tournament-style gameplay. The user may desire to monetize their gameplay by launching a plugin or widget configured to interact with computing device 902 to stream the gameplay to the user's subscribers (e.g., users of remote devices 910A-910N). As a result, users of remote devices 910A-910N may interact with computing device 902 to obtain a live stream of the gameplay. During the gameplay of video game 106, content overlay engine 104 of computing device 902 may continuously process video frames obtained from video game 106 in real-time or near real-time to identify elements of each video frame, determine a type of each identified element, and determine whether content (e.g., an advertisement) may be rendered on each element. In this illustrative example, the soccer players' jerseys of video game 106 may be identified as renderable elements, along with a “player-jersey” element type. Based on such an identification, content renderer 306 may be configured to dynamically embed different targeted advertisements for one or more streams transmitted to the remote devices. For example, one remote device in a first geographic location may receive a video stream that includes an overlay on the soccer players' jerseys for a locally brewed beverage, while another remote device in a second geographic location may receive a video stream that includes a different overlay on the players' jerseys for a vehicle manufacturer. In this manner, remotely located viewers of video game 106, depending on various factors such as the remotely located user's preferences, the remotely located user's locations, etc. may be presented with different content overlays for the same gameplay session, thus further enhancing the viewing experience for the remotely located users.

Furthermore, it is noted and understood that the example implementation described with respect to system 900 of FIG. 9 may be combined with any other features described herein. As an example, incentive provider 312 may be configured to provide incentives to any one or more user accounts associated with remote devices 910A-910N in accordance with example embodiments. For instance, incentive provider 312 may provide similar incentives (e.g., monetary awards, game credits, game achievements, game tokens, or any other offering based on a remote user's viewing of steams of video game 106 comprising content overlays. As a result, not only may the player of video game 106 receive incentives as described, but remotely located users may also receive incentives, thereby enhancing the gaming experience for a plurality of users across a gaming ecosystem.

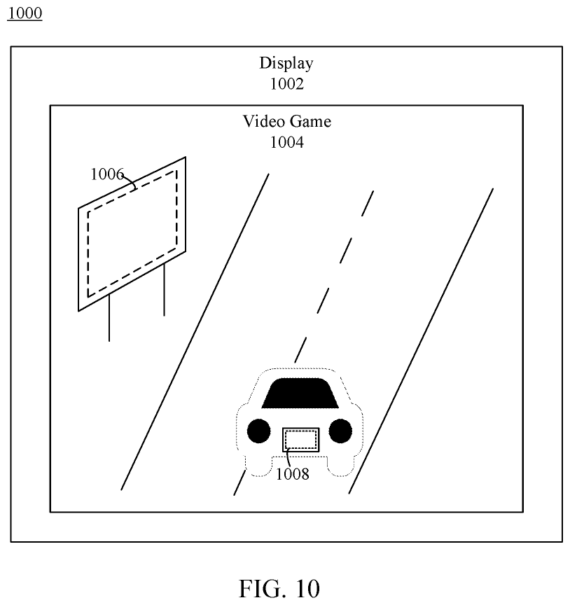

In example embodiments, content renderer 306 is configured to overlay content on the video frame generated by video game 106 such that a display device displays both the video frame of the video game 106 and the overlaid content simultaneously. For instance, FIG. 10 depicts example content overlays on a video frame of a video game implementing various techniques described herein, according to an example embodiment. FIG. 10 comprises a display device 1002 of a computing device (e.g., computing device 102, computing device 908, and/or any of remote devices 910A-910N) to which content overlay engine 104 may provide overlaid content on video frames generated by video game 106. Display device 1002 may display a video game 1004, similar to video game 106 described with reference to FIGS. 1, 3, and 9, along with one or more content overlays generated by content overlay engine 104.

FIG. 10, for example, illustrates various overlays that may be presented during the gameplay of video game 1004. For instance, a billboard advertisement 1006 presented on a billboard of a racing game that appears at a side of a roadway. As shown in FIG. 10, billboard advertisement 1006 may be rendered in a manner that is skewed to match a shape of the billboard in video game 1004 as described previously. One or more additional overlays, such as license plate advertisement 1008 on a vehicle of video game 1004, may also be presented in display 1002. Billboard advertisement 1006 and/or license plate advertisement 1008 may be selected in any appropriate manner described herein, including but not limited to based on video game 1004, the type of element (e.g., selecting a particular advertisement for a billboard and a different advertisement for a license plate), and/or based on one or more user characteristics (e.g., a location and/or preferences of a user or viewer of video game 1004).

It is noted that overlays illustrated in FIG. 10 are depicted only as illustrations, and may comprise any number or type of content overlay described herein, including but not limited to any shape, color, size, relative location on video game 1004, etc. In one further implementation, content renderer 306 may be configured to present any one or more overlays presented on display 1002 in a highlighted manner such that the overlaid element comprises an enhanced visibility to a user (e.g., by outlining the overlay, highlighting the overlay in a different color, enlarging the overlay, flashing the overlay in subsequent frames, etc.). In yet some other implementations, content renderer 306 may be configured to change any one or more overlays presented on the same element, such as by presenting a second advertisement on a billboard after a predetermined number of frames in which a first advertisement is overlaid on the same billboard.

In yet another example implementation, content renderer 306 may determine not to render an overlay in certain other situations. For instance if a video game player is having difficulty in video game 1004, content renderer 306 may determine not to render any overlays to reduce the likelihood that the video game player becomes distracted. In other examples, content renderer 306 may determine, based on a facial expression, verbal expression, or other emotion or expression captured via a camera and/or microphone in real-time or near real-time whether an overlay should be presented on display 1002. For instance, if a video game player is expressing certain behaviors (e.g., enjoyment, boredom, etc.), content renderer 306 may determine that a certain type of content (or no content) should be overlaid. As a result, content overlays may be provided in real-time or near-real time in a dynamic manner that may be tailored to each user's preferences, as well as the user's actual gameplay session.

### III. Example Computer System Implementation

One or more of the components of computing device 102, content overlay engine 104, video game 106, computing device 114, video game model generator 314, display 316, user account 320, computing device 902, network interface 906, computing device 908, remote devices 910A-910N, display 1002, and one or more steps of flowcharts 200, 400, 500, 600, 700, and 800 may be implemented in hardware, or hardware combined with software and/or firmware. For example, one or more of the components of computing device 102, content overlay engine 104, video game 106, computing device 114, video game model generator 314, display 316, user account 320, computing device 902, network interface 906, computing device 908, remote devices 910A-910N, display 1002, and one or more steps of flowcharts 200, 400, 500, 600, 700, and 800 may be implemented as computer program code/instructions configured to be executed in one or more processors and stored in a computer readable storage medium.

In another implementation, one or more of the components of computing device 102, content overlay engine 104, video game 106, computing device 114, video game model generator 314, display 316, user account 320, computing device 902, network interface 906, computing device 908, remote devices 910A-910N, display 1002, and one or more steps of flowcharts 200, 400, 500, 600, 700, and 800 may also be implemented in hardware that operates software as a service (SaaS) or platform as a service (PaaS). Alternatively, one or more of the components of computing device 102, content overlay engine 104, video game 106, computing device 114, video game model generator 314, display 316, user account 320, computing device 902, network interface 906, computing device 908, remote devices 910A-910N, display 1002, and one or more steps of flowcharts 200, 400, 500, 600, 700, and 800 may be implemented as hardware logic/electrical circuitry.

For instance, in an implementation, one or more of the components of computing device 102, content overlay engine 104, video game 106, computing device 114, video game model generator 314, display 316, user account 320, computing device 902, network interface 906, computing device 908, remote devices 910A-910N, display 1002, and one or more steps of flowcharts 200, 400, 500, 600, 700, and 800 may be implemented together in a system on a chip (SoC). The SoC may include an integrated circuit chip that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to perform functions.

FIG. 11 depicts an implementation of a computing device 1100 in which example embodiments may be implemented. For example, computing device 102, content overlay engine 104, video game 106, computing device 114, video game model generator 314, display 316, user account 320, computing device 902, network interface 906, computing device 908, remote devices 910A-910N, and/or display 1002 may each be implemented in one or more computing devices similar to computing device 1100 in stationary or mobile computer implementations, including one or more features of computing device 1100 and/or alternative features. The description of computing device 1100 provided herein is provided for purposes of illustration, and is not intended to be limiting. Example embodiments may be implemented in further types of computer systems, as would be known to persons skilled in the relevant art(s).

As shown in FIG. 11, computing device 1100 includes one or more processors, referred to as processor circuit 1102, a system memory 1104, and a bus 1106 that couple various system components including system memory 1104 to processor circuit 1102. Processor circuit 1102 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 1102 may execute program code stored in a computer readable medium, such as program code of operating system 1130, application programs 1132, other programs 1134, etc. Bus 1106 represents one or more of any of several types of bus structures, including a memory bus or memory controller, a peripheral bus, an accelerated graphics port, and a processor or local bus using any of a variety of bus architectures. System memory 1104 includes read only memory (ROM) 1108 and random-access memory (RAM) 1110. A basic input/output system 1112 (BIOS) is stored in ROM 1108.

Computing device 1100 also has one or more of the following drives: a hard disk drive 1114 for reading from and writing to a hard disk, a magnetic disk drive 1116 for reading from or writing to a removable magnetic disk 1118, and an optical disk drive 1120 for reading from or writing to a removable optical disk 1122 such as a CD ROM, DVD ROM, or other optical media. Hard disk drive 1114, magnetic disk drive 1116, and optical disk drive 1120 are connected to bus 1106 by a hard disk drive interface 1124, a magnetic disk drive interface 1126, and an optical drive interface 1128, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 1130, one or more application programs 1132, other programs 1134, and program data 1136. Application programs 1132 or other programs 1134 may include, for example, computer program logic (e.g., computer program code or instructions) for implementing one or more of the components of computing device 102, content overlay engine 104, video game 106, computing device 114, video game model generator 314, display 316, user account 320, computing device 902, content overlay engine 104, network interface 906, computing device 908, remote devices 910A-910N, display 1002, and one or more steps of flowcharts 200, 400, 500, 600, 700, and 800 and/or further implementations described herein.

A user may enter commands and information into the computing device 1100 through input devices such as keyboard 1138 and pointing device 1140. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 1102 through a serial port interface 1142 that is coupled to bus 1106, but may be connected by other interfaces, such as a parallel port, game port, or a universal serial bus (USB).

A display screen 1144 is also connected to bus 1106 via an interface, such as a video adapter 1146. Display screen 1144 may be external to, or incorporated in computing device 1100. Display screen 1144 may display information, as well as being a user interface for receiving user commands and/or other information (e.g., by touch, finger gestures, virtual keyboard, stylus, pen, pointing device, etc.). In addition to display screen 1144, computing device 1100 may include other peripheral output devices (not shown) such as speakers and printers. Display screen 1144, and/or any other peripheral output devices (not shown) may be used for implementing display 316 and/or display 1002, and/or any further implementations described herein.

Computing device 1100 is connected to a network 1148 (e.g., the Internet) through an adaptor or network interface 1150, a modem 1152, or other means for establishing communications over the network. Modem 1152, which may be internal or external, may be connected to bus 1106 via serial port interface 1142, as shown in FIG. 11, or may be connected to bus 1106 using another interface type, including a parallel interface.

As used herein, the terms “computer program medium,” “computer-readable medium,” and “computer-readable storage medium” are used to refer to physical hardware media such as the hard disk associated with hard disk drive 1114, removable magnetic disk 1118, removable optical disk 1122, other physical hardware media such as RAMs, ROMs, flash memory cards, digital video disks, zip disks, MEMs, nanotechnology-based storage devices, and further types of physical/tangible hardware storage media. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Implementations are also directed to such communication media that are separate and non-overlapping with implementations directed to computer-readable storage media.

As noted above, computer programs and modules (including application programs 1132 and other programs 1134) may be stored on the hard disk, magnetic disk, optical disk, ROM, RAM, or other hardware storage medium. Such computer programs may also be received via network interface 1150, serial port interface 1142, or any other interface type. Such computer programs, when executed or loaded by an application, enable computing device 1100 to implement features of example embodiments discussed herein. Accordingly, such computer programs represent controllers of the computing device 1100.

Implementations are also directed to computer program products comprising computer code or instructions stored on any computer-readable medium. Such computer program products include hard disk drives, optical disk drives, memory device packages, portable memory sticks, memory cards, and other types of physical storage hardware.

### IV. Additional Example Embodiments

A system for overlaying content on a video frame generated by a video game is described herein. The system includes: at least one processor circuit; at least one memory that stores program code, the program code including instructions to cause the at least one processor circuit to perform the actions of: executing a content overlay engine concurrently with the video game, the executing including: obtaining the video frame; identifying an element of the video game in the video frame; determining whether an overlay is renderable on the element; and overlaying the content on the element in the video frame based at least on a determination that the overlay is renderable.

In one implementation of the foregoing system, at least one of the identifying the element in the video game or the determining whether the overlay is renderable is based on an application of a machine learning-based model.

In another implementation of the foregoing system, the program code further comprises instructions to cause the at least one processor circuit to perform the action of: obtaining an advertisement based at least on one or more of the video game, a type of the element, a user location, or a user preference; and wherein the content comprises the obtained advertisement.

In another implementation of the foregoing system, the determining whether the overlay is renderable on the element is based at least on one or more prior executions of the video game by a particular user.

In another implementation of the foregoing system, the determining whether the overlay is renderable on the element based is at least on one or more prior executions of the video game by a plurality of users.

In another implementation of the foregoing system, the determining whether the overlay is renderable on the element is based on at least one of: a length of time the element was visible during at least one previous execution of the video game; a size of the element in the video frame; or a rate of movement of the element compared to a previous video frame.

In another implementation of the foregoing system, the overlaying the content on the element comprises blending the overlaid content into the video frame.

In another implementation of the foregoing system, the program code further comprises instructions to cause the at least one processor circuit to perform the action of providing an incentive to a user account associated with the video game based on the advertisement.

A method for overlaying content on a video frame generated by a video game is disclosed herein. The method includes: executing a content overlay engine concurrently with the video game, the executing the content overlay engine including: obtaining the video frame; identifying an element of the video game in the video frame; determining whether an overlay is renderable on the element; and overlaying the content on the element in the video frame based at least on a determination that the overlay is renderable.

In one implementation of the foregoing method, at least one of the identifying the element in the video game or the determining whether the overlay is renderable is based on an application of a machine learning-based model.

In another implementation of the foregoing method, the method further includes: obtaining an advertisement based at least on one or more of the video game, a type of the element, a user location, or a user preference; and wherein the content comprises the obtained advertisement.

In another implementation of the foregoing method, the determining whether the overlay is renderable is based at least on one or more prior executions of the video game by a particular user.

In another implementation of the foregoing method, the determining whether the overlay is renderable is based at least on one or more prior executions of the video game by a plurality of users.

In another implementation of the foregoing method, the determining whether the overlay is renderable is based on at least one of: a length of time the element was visible during at least one previous execution of the video game; a size of the element in the video frame; or a rate of movement of the element compared to a previous video frame.

A system for overlaying content on a video frame generated by a video game is disclosed herein. The system includes: at least one processor circuit; at least one memory that stores program code, the program code including instructions to cause the at least one processor circuit to perform the actions of: executing a content overlay engine concurrently with the video game, the executing including: obtaining the video frame; identifying an element of the video game in the video frame; generating a first output frame that comprises a first item of content overlaid on the element in the video frame; generating a second output frame that comprises a second item of content overlaid on the element in the video frame; and providing the first output frame to a first remote device and the second output frame to a second remote device.

In one implementation of the foregoing system, the program code further comprises instructions to cause the at least one processor circuit to perform the action of: determining whether an overlay is renderable on the element; and wherein the generating the first output frame comprising the first item of content and the generating the second output frame comprising the second item of content is based at least on a determination that the overlay is renderable.

In another implementation of the foregoing system, at least one of the identifying the element in the video game or the determining whether the overlay is renderable is based on an application of a machine learning-based model.

In another implementation of the foregoing system, the determining whether the overlay is renderable on the element is based on at least one of: a length of time the element was visible during at least one previous execution of the video game; a size of the element in the video frame; or a rate of movement of the element compared to a previous video frame.

In another implementation of the foregoing system, the program code further comprises instructions to cause the at least one processor circuit to perform the actions of: obtaining a first advertisement and a second advertisement based at least on one or more of the video game, a type of the element, a location of the first remote device, a location of the second remote device, or a user preference; and wherein the first item of content comprises the first advertisement and the second item of content comprises the second advertisement.

In another implementation of the foregoing system, the generating the first output frame comprising the first item of content and the generating the second output frame comprising the second item of content comprises blending the first item of content in the first output frame and blending the second item of content in the second output frame, respectively.

### V. Conclusion

While various example embodiments have been described above, it should be understood that they have been presented by way of example only, and not limitation. It will be understood by those skilled in the relevant art(s) that various changes in form and details may be made therein without departing from the spirit and scope of the embodiments as defined in the appended claims. Accordingly, the breadth and scope of the present invention should not be limited by any of the above-described example embodiments, but should be defined only in accordance with the following claims and their equivalents.

What is claimed is:

1. A system for overlaying content on a video frame generated by a video game, the system comprising:
at least one processor circuit;
at least one memory that stores program code, the program code including instructions to cause the at least one processor circuit to perform the actions of:
executing a content overlay engine concurrently with the video game, the executing including:
obtaining the video frame;
identifying an element of the video game in the video frame;
determining whether an overlay is renderable on the element; and
overlaying the content on the element in the video frame based at least on a determination that the overlay is renderable.

2. The system of claim 1, wherein at least one of the identifying the element in the video game or the determining whether the overlay is renderable is based on an application of a machine learning-based model.

3. The system of claim 1, wherein the program code further comprises instructions to cause the at least one processor circuit to perform the action of:
obtaining an advertisement based at least on one or more of the video game, a type of the element, a user location, or a user preference; and
wherein the content comprises the obtained advertisement.

4. The system of claim 1, wherein the determining whether the overlay is renderable on the element is based at least on one or more prior executions of the video game by a particular user.

5. The system of claim 1, wherein the determining whether the overlay is renderable on the element is based at least on one or more prior executions of the video game by a plurality of users.

6. The system of claim 1, wherein the determining whether the overlay is renderable on the element is based on at least one of:
a length of time the element was visible during at least one previous execution of the video game;
a size of the element in the video frame; or
a rate of movement of the element compared to a previous video frame.

7. The system of claim 1, wherein the overlaying the content on the element comprises blending the overlaid content into the video frame.

8. The system of claim 3, wherein the program code further comprises instructions to cause the at least one processor circuit to perform the action of:
providing an incentive to a user account associated with the video game based on the advertisement.

9. A method for overlaying content on a video frame generated by a video game, the method comprising:
executing a content overlay engine concurrently with the video game, the executing the content overlay engine including:
obtaining the video frame;
identifying an element of the video game in the video frame;
determining whether an overlay is renderable on the element; and
overlaying the content on the element in the video frame based at least on a determination that the overlay is renderable.

10. The method of claim 9, wherein at least one of the identifying the element in the video game or the determining whether the overlay is renderable is based on an application of a machine learning-based model.

11. The method of claim 9, further comprising:
obtaining an advertisement based at least on one or more of the video game, a type of the element, a user location, or a user preference; and
wherein the content comprises the obtained advertisement.

12. The method of claim 9, wherein the determining whether the overlay is renderable is based at least on one or more prior executions of the video game by a particular user.

13. The method of claim 9, wherein the determining whether the overlay is renderable is based at least on one or more prior executions of the video game by a plurality of users.

14. The method of claim 9, wherein the determining whether the overlay is renderable is based on at least one of:
a length of time the element was visible during at least one previous execution of the video game;
a size of the element in the video frame; or
a rate of movement of the element compared to a previous video frame.

15. A system for overlaying content on a video frame generated by a video game, the system comprising:
at least one processor circuit;
at least one memory that stores program code, the program code including instructions to cause the at least one processor circuit to perform the actions of:
executing a content overlay engine concurrently with the video game, the executing including:
obtaining the video frame;
identifying an element of the video game in the video frame;
generating a first output frame that comprises a first item of content overlaid on the element in the video frame;
generating a second output frame that comprises a second item of content overlaid on the element in the video frame; and
providing the first output frame to a first remote device and the second output frame to a second remote device.

16. The system of claim 15, wherein the program code further comprises instructions to cause the at least one processor circuit to perform the action of:
determining whether an overlay is renderable on the element; and
wherein the generating the first output frame comprising the first item of content and the generating the second output frame comprising the second item of content is based at least on a determination that the overlay is renderable.

17. The system of claim 16, wherein at least one of the identifying the element in the video game or the determining whether the overlay is renderable is based on an application of a machine learning-based model.

18. The system of claim 16, wherein the determining whether the overlay is renderable on the element is based on at least one of:
a length of time the element was visible during at least one previous execution of the video game;
a size of the element in the video frame; or
a rate of movement of the element compared to a previous video frame.

19. The system of claim 15, wherein the program code further comprises instructions to cause the at least one processor circuit to perform the actions of:
obtaining a first advertisement and a second advertisement based at least on one or more of the video game, a type of the element, a location of the first remote device, a location of the second remote device, or a user preference; and
wherein the first item of content comprises the first advertisement and the second item of content comprises the second advertisement.

20. The system of claim 15, wherein the generating the first output frame comprising the first item of content and the generating the second output frame comprising the second item of content comprises blending the first item of content in the first output frame and blending the second item of content in the second output frame, respectively.
